(19) United States
(12) Patent Application Publication
(10) Pub. No.: US 2006/0098076 A1
(43) Pub. Date: May 11, 2006

(54) Desktop Personal Digital Cosmetics Make Up Printer

(76) Inventor: Jason J. Liang, Huntington Beach, CA (US)

Correspondence Address: JASON J. LIANG, 6761 WALTON DRIVE, HUNTINGTON BEACH, CA, 92647, US

(21) Appl. No.: 10/710,535

(22) Filed: Nov. 5, 2004

(51) Int. Cl. B41J 2/385

(52) U.S. Cl. 347/129

(57) ABSTRACT

This invention discloses a system for providing a desktop digital personal make up Cosmetics system which can raise the speed of cosmetics many time faster and much detail than traditional way. A desktop digital lnkjet eye brow and face make up printer comprising with flexible adjustable track rail, Profile set up adjustable thumb screws, inkjet cartridge carrier and ink cartridge which contain the oil base or water based edible color ink, dye or pigmented ink, X-Y axis Ball screw servo drive, telescopic leg and electronic motion control, position encoder, digital image process and piezoelectric print head nozzle drive.

### BACKGROUND OF INVENTION

Make up, Cosmetics have to fellow fashion stream and also it is aspects of age and job oriented. It take long time to do the Make up, especially a good make up will take people hours or whole day to finish it. It is very hard to draw a high resolution and smooth gray level and eye vivid brow and cheek blush by your own hand only, for instance most eye bow drawn by hands are just like solid color line, lack of both details and nature look, eye brow suppose made up of tiny hairs but pensile just can not do that detail. Compare the photo of the eye bow and the make up eye bow, there is big difference between them.

Even permanent make-up machine can not do those details as digital photo, also permanent make-up once it is done it can not be changed in other style, color and others. To achieve a photographic level eye brow that can see the detail and give people vivid nature look, this invention comprise utilize piezoelectric print head or thermal print head digital printing technology make a dedicated desktop digital personal high resolution facial make up Cosmetics printer piezoelectric

### SUMMARY OF INVENTION

A PC based personal desktop Cosmetics digital printer comprising the modern digital graphic and inkjet printing technology, make the digital quality make-up close to photographic quality, all deals will be expressed. The cartridge print head track rail can be adjusted based on profile of human head and face. X-Y axis motion control and piezoelectric print head that with CMYK color ink to finish the facial make up which usually done by hands. All the styles are stored in PC and favor style can be saved, edited and used again.

### BRIEF DESCRIPTION OF DRAWINGS

FIG. 1 is the general looking Make up printer 3D.

FIG. 2 is illustration of the top view to the printer and human head and x axis drive assembly.

FIG. 3 is illustration of the lnkjet cartridge Carrier and the guiding wheel.

FIG. 4 is the carrier assembly and guiding wheel.

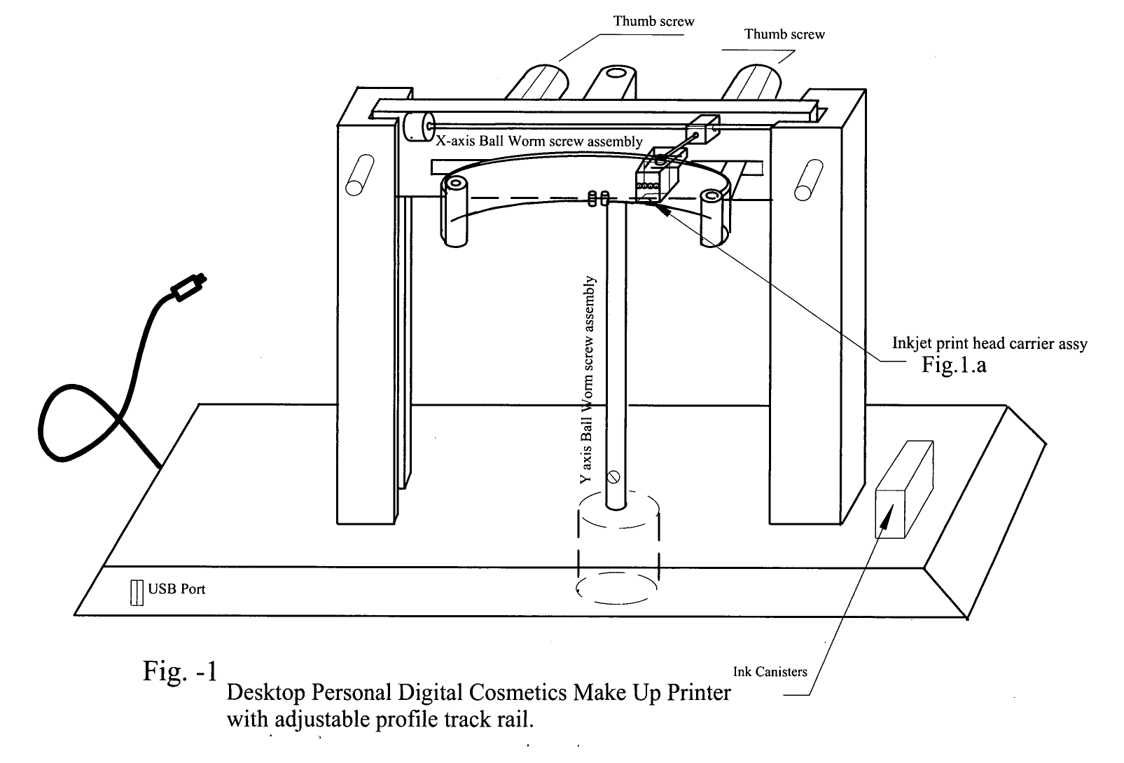

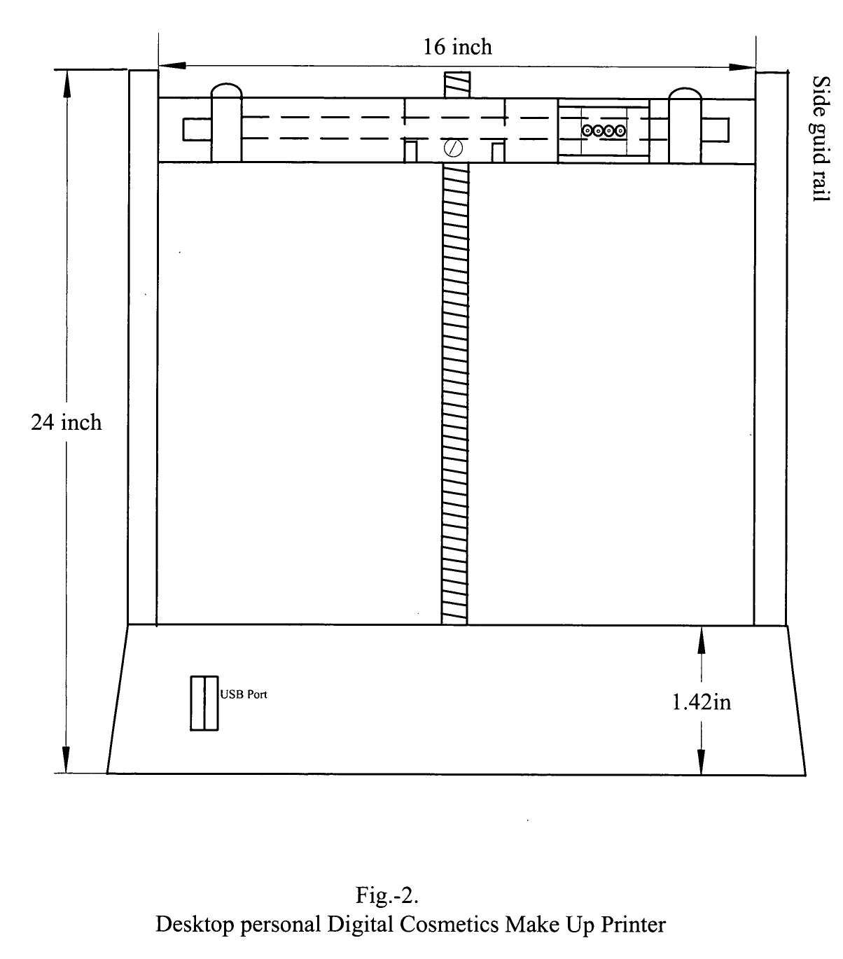

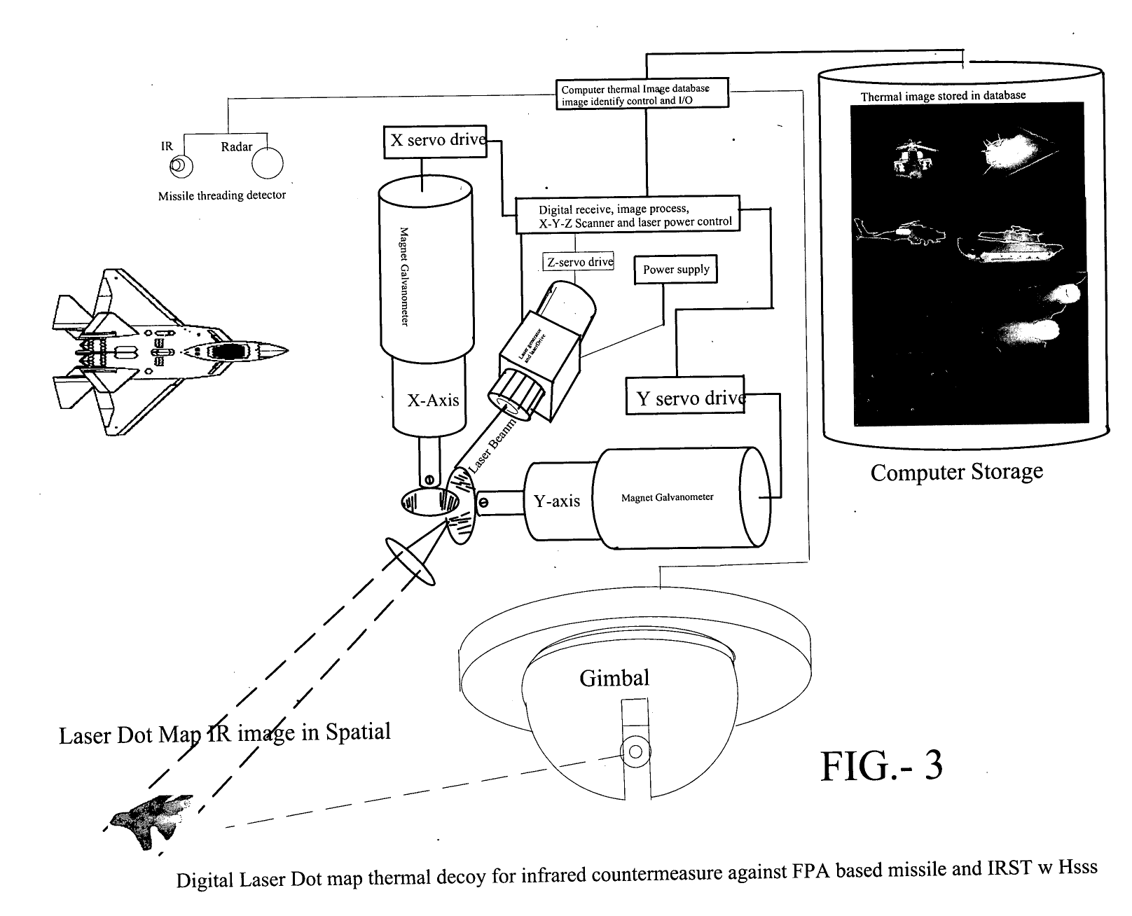

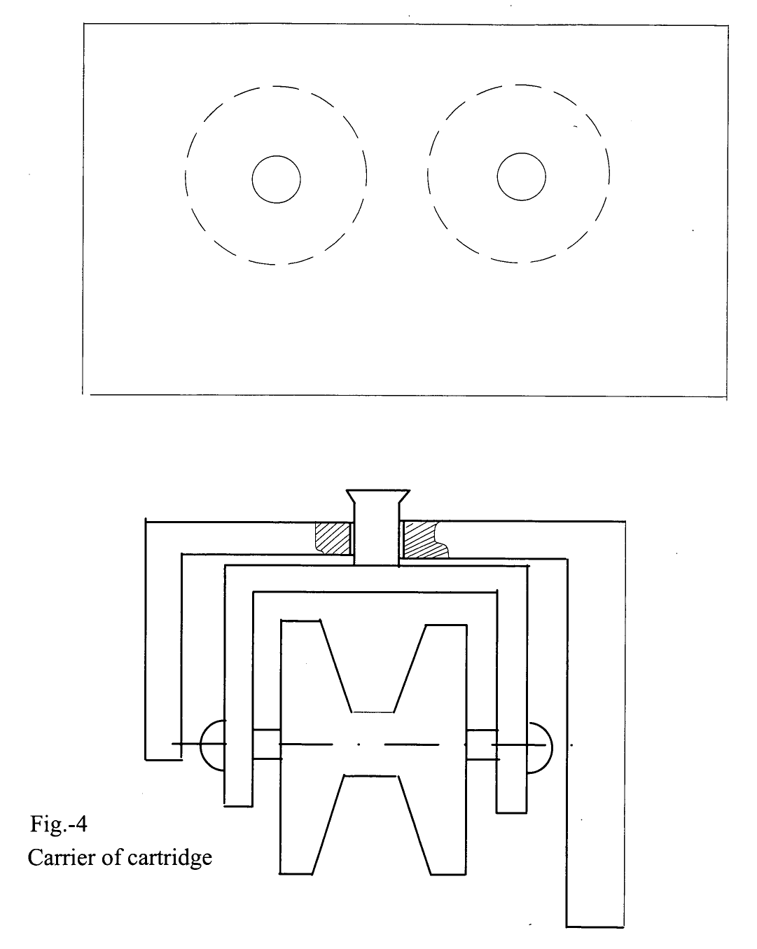

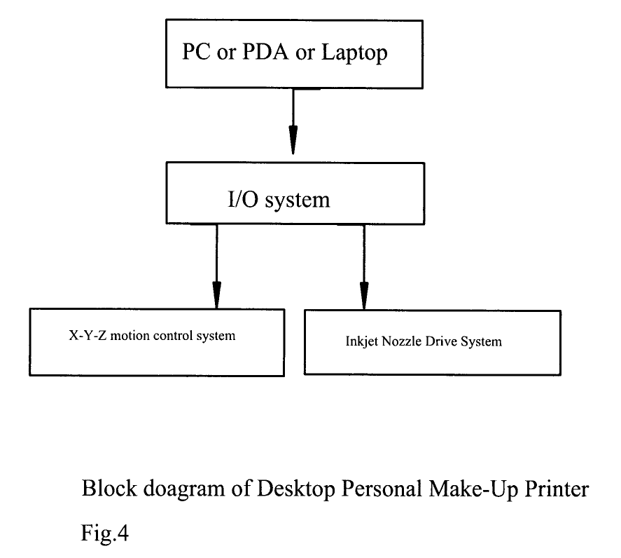

### DETAILED DESCRIPTION

This personal desktop digital Cosmetics printer operated with PC and photographic software. In order to let inkjet cartridge print head print on the right position within the shooting range of the print head, the printer has a profile adjustable track rail, which can be adjusted according to the profile of human face and head shape, such as the eye bow or cheek. The track made by steel plate or composite material with both tiff and flexible character. The style, size, color and gray scale level is controlled by computer photographic software. The current Micro piezoelectric print head nozzle can print 300, 600,1200, 1400dpi resolution that mean it can print a hair in photographic quality, people can have real eye bow printed on her forehead in 10 seconds and a favor style can be saved in PC and using again. This will save a lot of time and patience. The cheek blushing printing is also very easy, call out a blushing style and color and just print on face then smear it with brush. People will get a perfect make up within a minute. System can store all kinds of eye brow and cheek blush from the movie star or and popular style and own favor make up Cosmetics style and digital effect images in PC and try them on the face. The ink used for this printer can be pigmented or dye based, can be water based, solvent based and oil based. Print head driven by X axis motor in horizontal and driven by Y Axis motor in vertical, map the ink drop dot to the location desired.

1. Desktop Personal Digital Make Up Printer.
Comprising, Data Input Interface, X-Y servo and step motor drive assembly, piezoelectric print head Drive circuit board, CMYK inkjet cartridges carrier.

2. Flexible track rail can be adjust according to profile of each person face And head. Two thumb screw can bend or stretch the flexible track rail. Rail can be made by steel or composite material plate.
A length auto adjustable telescopic leg is coupled with carrier and used to pull or push the cartridge carrier that rides on the curved rail to do the left right scanning and compensating the arc of the rail. This telescopic leg can be a linear motor driven or spring driven system.

3. Carrier of ink cartridge assembly The train wheel can clamps the rail edge and fellow the track arc. Whole assembly comprise X axis step motor or servo motor, ball screw worm and nut assembly and telescopic leg and cartridge Carrier The Y Axis drive assembly control the vertical motion of the Carrier of ink cartridge assembly the print head assembly. X - Y axis 2 dimension sion motion, open loop or close loop control, can let print head shooting ink at any position of the human face that computer programmed.

4. Database of all kind of eye brow, face blush, logo, symbols, and texture vector image, and some.
Recommended style and color are stored. Customer can make its on eye brow picture and print and save. All eye brow, face blush image can be edited, such as brightness, contrast, Color, special effection, skew, stretch Scale, hue, saturation and color gamma.

5. The printer can print left of the face and then print the right side of the face or print both side at same time.
